(19) United States
(12) Patent Application Publication
(10) Pub. No.: US 2015/0165472 A1
(43) Pub. Date: Jun. 18, 2015

(54) COATING APPARATUS AND METHOD FOR PRODUCING COATING FILM

(71) Applicant: NIITO DENKO CORPORATION, Osaka (JP)

(72) Inventors: Makoto Komatsubara, Ibaraki-shi (JP); Hajime Michihira, Ibaraki-shi (JP); Masashi Miyake, Ibaraki-shi (JP)

(73) Assignee: NITTO DENKO CORPORATION, Osaka (JP)

(21) Appl. No.: 14/504,587

(22) Filed: Oct. 2, 2014

(30) Foreign Application Priority Data
Dec. 18, 2013 (JP) 2013-261335

(51) Int. Cl. B05C 11/10; B05D 1/00; B05C 9/00

(52) U.S. Cl. CPC B05C 11/1013; B05C 9/00; B05D 1/00

(57) ABSTRACT

A coating apparatus includes: a coating unit configured to form a coating film by applying a coating liquid containing a component to be solidified onto a sheet that is relatively moving and by solidifying the applied coating liquid; a liquid delivering unit configured to deliver the coating liquid to the coating unit; a measuring unit configured to measure a mass flow rate of the coating liquid and arranged between the liquid delivering unit and the coating unit; and a control unit storing a reference value of the mass flow rate and configured to change the mass flow rate of the coating liquid to be delivered by the liquid delivering unit on the basis of the reference value and a measurement result by the measuring unit.

### CROSS-REFERENCE TO RELATED APPLICATION

This application claims priority to Japanese Patent Application No. 2013-261335, filed on Dec. 18, 2013, the disclosure of which is incorporated herein by reference in its entirety.

### BACKGROUND OF THE INVENTION

1. Field of the Invention

The present invention relates to a coating apparatus and a method for producing a coating film.

2. Background Art

Conventionally, a coating apparatus, which is configured to form a coating film by applying a coating liquid to a sheet, including a coating unit that applies the coating liquid containing a component to be solidified onto the sheet, and a liquid delivering unit that delivers the coating liquid to the coating unit has been used. In such a coating apparatus, variation in the amount of the coating liquid to be discharged from the coating unit causes variation in the thickness of the coating film thus obtained, which may result in that the coating film cannot exhibit desired performance.

Therefore, a coating apparatus configured to control the amount of the coating liquid to be discharged from the coating unit by controlling the amount of the coating liquid to be delivered to the coating unit has been proposed.

For example, a coating apparatus including a liquid delivering unit that delivers a coating liquid to a coating unit, a measuring unit that is arranged between the liquid delivering unit and the coating unit so as to measure the amount of the coating liquid to be delivered, and a control unit that changes the amount of the coating liquid to be delivered by the liquid delivering unit on the basis of a measurement result by the measuring unit has been proposed (see JP 2007-330935 A and JP 2011-194329 A).

### SUMMARY OF THE INVENTION

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In the aforementioned Patent Literatures, a volumetric flow rate is measured as the amount of the coating liquid to be delivered, so that the amount of the coating liquid to be delivered (that is, the volumetric flow rate) is adjusted on the basis of the measurement result of the volumetric flow rate. However, there are cases where the coating apparatuses of these patent literatures cannot sufficiently yield a coating film having a desired thickness.

On the other hand, it is also conceivable to measure the thickness of the coating film formed on the sheet and change the amount of the coating liquid to be delivered on the basis of the measurement result. However, such adjustment requires a comparatively long distance and time before the adjustment of the coating liquid in the liquid delivering unit is reflected in the measurement result of the coating film. Therefore, there is a possibility that variation in the thickness of the coating film cannot be quickly reflected in changing the amount of the coating liquid to be delivered, which also may lead to a waste of the coating liquid.

In view of such problems, the present invention aims to provide a coating apparatus and a method for producing a coating film which enable comparatively quick and reliable suppression of variation in the thickness of the coating film with no waste.

As a result of diligent studies by the inventors on the relationship between the amount of the coating liquid to be delivered and the thickness of the formed coating film, it has been revealed that the volume of the coating liquid may vary depending on the environmental temperature surrounding the coating apparatus, and therefore use of the volumetric flow rate as an indicator of the amount of liquid to be delivered may result in a failure to sufficiently suppress variation in the thickness of the resultant coating film, due to the aforementioned variation of the volume. As a result of additional studies by the inventors on the basis of such understanding, they have found that the variation in the thickness of the obtained coating film can be more suppressed by using the mass flow rate as an indicator of the amount of liquid to be delivered, thereby accomplishing the present invention.

That is, a coating apparatus according to the present invention includes: a coating unit configured to form a coating film by applying a coating liquid containing a component to be solidified onto a sheet that relatively moves and by solidifying the applied coating liquid; a liquid delivering unit configured to deliver the coating liquid to the coating unit; a measuring unit configured to measure a mass flow rate of the coating liquid and arranged between the liquid delivering unit and the coating unit; and a control unit storing a reference value of the mass flow rate and configured to change the mass flow rate of the coating liquid to be delivered by the liquid delivering unit on the basis of the reference value and a measurement result by the measuring unit.

According to such a configuration, the amount of the coating liquid to be delivered can be measured by the measuring unit arranged between the liquid delivering unit and the coating unit, and therefore variation in the thickness of the coating film can be suppressed quickly and with no waste, as compared to the case of measuring the thickness of the coating film.

Moreover, the mass flow rate is used as an indicator of the amount of the coating liquid to be delivered, and the mass flow rate of the coating liquid is measured by the measuring unit, so that the flow rate of the coating liquid can be changed on the basis of the measurement result by the measuring unit and a reference value of the mass flow rate. Therefore, it is possible to suppress the variation in the thickness of the coating film more reliably than in the case of using the volumetric flow rate as an indicator.

Accordingly, the coating apparatus with such a configuration can suppress variation in the thickness of the coating film comparatively quickly and reliably with no waste.

In the coating apparatus with such a configuration, it is preferable that the reference value be determined on the basis of a mass fraction of the component to be solidified in the coating liquid that is applied onto the sheet.

According to such a configuration, the reference value is determined on the basis of the mass fraction of the component to be solidified in the coating liquid applied onto the sheet, thereby allowing the reference value to be set on the basis of the mass fraction of the component to be solidified in the coating liquid, which is correlated with the thickness of the coating film. Accordingly, it is possible to change the mass flow rate more suitably.

In the coating apparatus with such a configuration, it is preferable that the reference value be determined on the basis of the following formulas (1) and (2).

$$\begin{matrix}S = \frac{W \times U \times t\_ref \times ρ\_s}{B} & ( 1 ) \\ ρ\_s = \frac{t\_ref \times ρ\_a}{t\_ms} & ( 2 )\end{matrix}$$

S: Reference value of mass flow rate (kg/min)
W: Set value of width of coating liquid applied to sheet (m)
U: Moving speed of sheet relative to coating unit (m/min)
t_ref: Set value of thickness of coating film applied to sheet and solidified thereon (m)
ρ_s: Density of coating film applied to sheet and solidified thereon (kg/m³)
B: Mass fraction of component to be solidified in coating liquid (−)
ρ_a: Preliminarily set value of density of coating film applied to sheet and solidified thereon (kg/m³)
t_ms: Measured value of thickness of coating film applied to sheet and solidified thereon (m).

In the coating apparatus with such a configuration, it is preferable that a value of the aforementioned B be determined using one of the following formulas (3) to (5).

$$\begin{matrix}B = \frac{\begin{matrix}Mass of component to be \\ solidified in coating liquid\end{matrix} }{\begin{matrix}( Mass of component to be \\ solidified in coating liquid )\end{matrix} + \begin{matrix}( Mass of component to be \\ removed due to \\ solidification from coating \\ liquid )\end{matrix}} & ( 3 ) \\ B = \frac{Mass of coating film after solidification}{Mass of coating film before solidification} & ( 4 ) \\ B = a \times ρ\_L + b \times T + c & ( 5 )\end{matrix}$$

ρ_L: Measured value of density of coating liquid (kg/m³)
T: Temperature of coating liquid during application (° C.)

### a, b, c: Coefficient (−)

A method for producing a coating film of the present invention includes: by using the aforementioned coating apparatus, forming a coating film by applying the coating liquid onto the sheet by the coating unit, while measuring the mass flow rate of the coating liquid by the measuring unit and changing, by the control unit, the mass flow rate to be delivered by the liquid delivering unit on the basis of the reference value and the measurement result by the measuring unit.

### BRIEF DESCRIPTION OF THE DRAWINGS

The foregoing and other features of the present invention will become apparent from the following description and drawings of an illustrative embodiment of the invention in which:

FIG. 1 is a schematic configuration diagram of a coating apparatus according to one embodiment of the present invention;

FIG. 2 is a schematic side view showing an example of the state where a coating liquid is applied on a sheet, using the coating apparatus of this embodiment;

FIG. 3 is a schematic side view showing an example of the state where a coating liquid is applied on a sheet, using the coating apparatus of this embodiment; and

FIG. 4 is a schematic side view showing an example of the state where a coating liquid is applied on a sheet, using the coating apparatus of this embodiment.

### DETAILED DESCRIPTION OF THE PREFERRED EMBODIMENT

Hereinafter, embodiments of a coating apparatus and a method for producing a coating film using the coating apparatus according to the present invention are described with reference to the drawings.

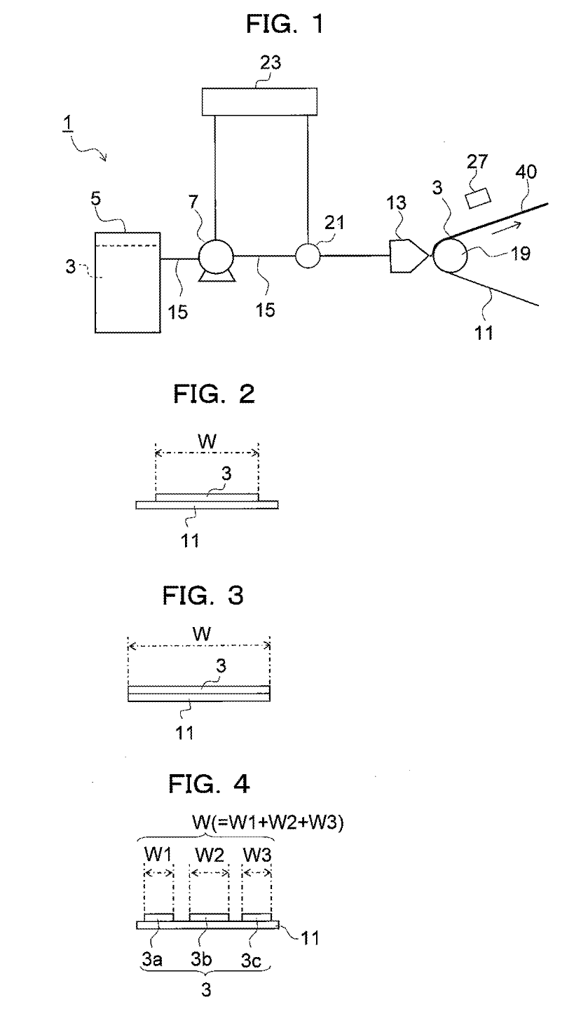

As shown in FIG. 1, a coating apparatus 1 of this embodiment includes: a container 5 that contains a coating liquid 3 containing a component to be solidified; a pump 7 as a liquid delivering unit that delivers the coating liquid 3 from the container 5 toward the downstream side; a coating unit 13 that forms a coating film 40 by applying the coating liquid 3, which is delivered by the pump 7, sequentially to a sheet 11 having a strip shape that is relatively moving toward the downstream side along the longitudinal direction (see the solid arrow); a measuring unit 21 that is arranged between the pump 7 and the coating unit 13 and measures the mass flow rate of the coating liquid 3 delivered to the coating unit 13 by the pump 7; a control unit 23 that stores a reference value S and causes the pump 7 to change the mass flow rate on the basis of the reference value S and a measurement result D by the measuring unit 21; conduits 15 that form a moving path of the coating liquid 3; and a supporting unit 19 that supports the sheet 11. Further, the coating apparatus 1 includes a solidification unit 27 that solidifies the coating liquid 3 applied onto the sheet 11.

The coating liquid 3 contains a component to be solidified and is applied to the sheet 11 so as to be solidified on the sheet 11. Examples of the coating liquid 3 include polymer solutions. Examples of materials used for the aforementioned component to be solidified include thermosetting materials, ultraviolet curable materials, and electron beam curable materials.

Further, examples of the sheet 11 include resin films. FIG. 1 shows an embodiment in which the sheet 11 has an elongated shape and flexibility. However, it is also possible to employ an embodiment in which the sheet 11 is in the form of a single plate, or has no flexibility, other than above.

The container 5 contains the coating liquid 3 used for coating of the sheet 11. As the container 5, tanks made of metal can be mentioned, for example.

The pump 7 delivers the coating liquid 3 contained in the container 5 toward the downstream side to the coating unit 13. Examples of the pump 7 include conventionally known pumps such as a gear pump, a diaphragm pump, a plunger pump, and a single eccentric screw pump.

The coating unit 13 applies the coating liquid 3 delivered from the pump 7 sequentially to the sheet 11 with a strip shape that is moving toward the downstream side relatively to the coating unit 13 while the sheet 11 is supported by the supporting unit 19 such as a roller. As the coating unit 13, a die coater can be mentioned, for example.

The conduits 15 are respectively connected between the container 5 and the pump 7, and between the pump 7 and the coating unit 13, so as to form a path that allows the coating liquid 3 to move therethrough from the container 5 to the coating unit 13 via the pump 7.

Examples of such conduits 15 include tubes that are formed to have a cylindrical shape using metal materials, composite materials as a mixture of resin and metal, or resin materials.

The supporting unit 19 supports the sheet 11 that is moving in the longitudinal direction, from the opposite side of the coating unit 13. As the supporting unit 19, rollers can be mentioned, for example.

The measuring unit 21 measures the mass flow rate of the coating liquid 3 to be delivered by the pump 7 to the coating unit 13. The measuring unit 21 is arranged in the conduit 15 between the pump 7 and the coating unit 13. The measuring unit 21 measures the mass flow rate of the coating liquid 3 and transmits the measurement result D to the control unit 23 as electronic data.

As the measuring unit 21, flow meters can be mentioned, and such a flow meter is not specifically limited as long as it is capable of measuring the mass flow rate. Examples of the flow meters include flow meters of the positive displacement type, the area type, the turbine type, the differential pressure type, the electromagnetic type, the vortex type, the ultrasonic type, the Coriolis type, and the thermal type.

The control unit 23 stores the reference value S of the mass flow rate of the coating liquid 3 as electronic data, and receives the measurement result D transmitted from the measuring unit 21 as electronic data, so as to change the amount of the coating liquid 3 to be delivered (that is, the mass flow rate) by the pump 7 on the basis of the reference value S and the measurement result D.

Specifically, the control unit 23 has a function to compare the received measurement result D with the reference value 5, so that the control unit 23 reduces the amount of liquid to be delivered by the pump 7 (that is, the mass flow rate) if the measurement result D is larger than the reference value S, and increases the amount of liquid to be delivered by the pump 7 (that is, the mass flow rate) if the measurement result D is smaller than the reference value S.

The solidification unit 27 is a device for solidifying the coating liquid 3. The solidification unit 27 is appropriately selected depending on the kind of the coating liquid 3. Examples thereof include heating devices of the hot air type and the infrared radiation (IR) type, ultraviolet (UV) irradiators, and electron beam (EB) irradiators. Specifically, in the case where the coating liquid 3 contains a material that is cured by heating, the aforementioned heating devices can be used. In the case where the coating liquid 3 contains a material that is cured by irradiation with ultraviolet rays, the aforementioned ultraviolet irradiators can be used. In the case where the coating liquid 3 contains a material that is cured by irradiation with electron beams, the aforementioned electron beam irradiators can be used. The present invention also may have a configuration in which the coating apparatus has no solidification unit, depending on the type of the coating liquid 3.

In this embodiment, the reference value S is determined on the basis of the mass fraction of the component to be solidified in the coating liquid 3 that is applied onto the sheet 11.

When the reference value S is determined as above on the basis of the mass fraction of the component to be solidified in the coating liquid 3 that is applied onto the sheet 11, the reference value is set on the basis of the mass fraction of the component to be solidified in the coating liquid 3, which is correlated with the thickness of the coating film 40. Accordingly, it is possible to adjust the mass flow rate more suitably.

Specifically, the reference value S is determined on the basis of the following formulas (1) and (2).

$$\begin{matrix}S = \frac{W \times U \times t\_ref \times ρ\_s}{B} & ( 1 ) \\ ρ\_s = \frac{t\_ref \times ρ\_a}{t\_ms} & ( 2 )\end{matrix}$$

S: Reference value of mass flow rate (kg/min)
W: Set value of width of coating liquid applied to sheet (m)
U: Moving speed of sheet relative to coating unit (m/min)
t_ref: Set value of thickness of coating film applied to sheet and solidified thereon (m)
ρ_s: Density of coating film applied to sheet and solidified thereon (kg/m³)
B: Mass fraction of component to be solidified in coating liquid (−)
ρ_a: Preliminarily set value of density of coating film applied to sheet and solidified thereon (kg/m³)
t_ms: Measured value of thickness of coating film applied to sheet and solidified thereon (m)

The aforementioned S denotes a reference value of the mass flow rate, and is a value calculated from the above formula (1).

In the above formula (1), the aforementioned W denotes a set value of a width W of the coating liquid 3 applied onto the sheet 11, and corresponds to the width of the coating film 40. The value of W can be appropriately set in advance depending, for example, on the kind of the coating film 40 to be obtained.

It should be noted that the shape of the coating liquid 3 on the sheet 11 (that is, the shape of the coating film 40) is not specifically limited. Further, the coating liquid 3 on the sheet 11 may be applied, for example, as one piece of the coating liquid 3 that is continuous in the moving direction of the sheet 11, or as multiple intermittent pieces of the coating liquid 3. Furthermore, the coating liquid 3 on the sheet 11 may be applied, for example, as one piece of the coating liquid 3 that is continuous in the width direction (direction perpendicular to the moving direction) of the sheet 11, or as multiple intermittent pieces of the coating liquid 3.

The width W of the coating liquid 3, for example, is the width of the coating liquid 3 in the case where one piece of the coating liquid 3 is applied onto the sheet 11 in the width direction, and the width of the coating liquid 3 is narrower than that of the sheet 11, as shown in FIG. 2. The width W is the width of the sheet 11 in the case where the width of the coating liquid 3 is the same as the width of the sheet 11, as shown in FIG. 3. Further, in the case where multiple pieces of the coating liquid 3 are applied onto the sheet 11 at intervals in the width direction, as shown in FIG. 4, the width of the coating liquid 3 applied onto the sheet 11 is the total of the width of the pieces of the coating liquid 3. For example, in the case where three pieces of the coating liquid 3 are applied at intervals in the width direction, the width of the coating liquid 3 applied onto the sheet 11 is the total of the width W1, W2 and W3 of the three pieces 3a, 3b, 3c of the coating liquid (W=W1+W2+W3).

The aforementioned U denotes a moving speed of the sheet 11 relative to the coating unit 13. Further, the value of U can be appropriately set in advance depending, for example, on the kind of the coating film 40 to be obtained.

The aforementioned t_ref denotes a set value of the thickness of the coating film 40 to be obtained by being applied to the sheet 11 and solidified thereon. The value of t_ref can be appropriately set in advance depending, for example, on the kind of the coating film 40.

The aforementioned B denotes the mass fraction of the component to be solidified in the coating liquid 3. The value of B can be appropriately set in advance depending, for example, on the kind of the coating liquid 3. The value of B, for example, can be calculated by one of the formulas (3) to (5) which will be described later.

The aforementioned ρ_s denotes the density of the coating film 40 applied to the sheet 11 and solidified thereon, and is a value calculated from the above formula (2).

In the above formula (2), the ρ_a denotes a preliminarily set value of the density of the coating film 40 applied to the sheet 11 and solidified thereon. The value of ρ_a can be appropriately set in advance depending, for example, on the kind of the coating liquid 3.

The aforementioned t_ms denotes a measured value of the thickness of the coating film 40 applied to the sheet 11 and solidified thereon. The value of t_ms is a value obtained by measuring the thickness of the coating film 40 after solidification when the coating liquid 3 is applied onto the sheet 11 under the conditions where the value of ρ_s in the above formula (1) is set as the aforementioned preliminarily set value ρ_a of the density in a preliminary experiment, etc.

When the reference value S is determined on the basis of the above formulas (1) and (2), there is an advantage that only one time of preliminary experiment is required to be conducted, since the same value can be used as ρ_s, even if the values of W, U, t_ref, and B are varied, as long as the kind of the coating liquid 3 is the same.

The aforementioned reference value S is determined as follows. That is, the value of the density of the coating film 40 is set as the preliminarily set value ρ_a in a preliminary experiment, etc. Further, the thickness is set as the set value t_ref, the width is set as W, the moving speed is set as U, and the value of B is further obtained as described below. Then, a preliminarily reference value S′ is determined using the above formula (1). Under such setting conditions, the coating liquid 3 is applied to the sheet 11 so that a coating film after solidification is obtained. The thickness of the coating film thus obtained is measured so that the value of t_ms is obtained. Then, the value of ρ_s is obtained using the above formula (2) from the values of t_ref, ρ_a, and t_ms.

Further, the reference value S is determined using the above formula (1) from the values of W, U, t_ref, ρ_s, and B.

In this embodiment, the value of B is determined using one of the following formulas (3) to (5).

$$\begin{matrix}B = \frac{\begin{matrix}Mass of component to be \\ solidified in coating liquid\end{matrix} }{\begin{matrix}( Mass of component to be \\ solidified in coating liquid )\end{matrix} + \begin{matrix}( Mass of component to be \\ removed due to \\ solidification from coating \\ liquid )\end{matrix}} & ( 3 ) \\ B = \frac{Mass of coating film after solidification}{Mass of coating film before solidification} & ( 4 ) \\ B = a \times ρ\_L + b \times T + c & ( 5 )\end{matrix}$$

ρ_L: Measured value of density of coating liquid (kg/m³)
T: Temperature of coating liquid during application (° C.)

### a, b, c: Coefficient (−)

The aforementioned ρ_L denotes a measured value of the density of the coating liquid 3.

The aforementioned T denotes a measured value of the temperature of the coating liquid 3 during application.

The aforementioned a, b, and c each denote a coefficient, and can be appropriately set in advance depending on the kind of the coating liquid 3.

When a value that is determined on the basis of one of the above formulas (3) to (5) is used as the aforementioned B, only the value of B is required to be changed even if the value of B is changed between an experiment to obtain ρ_s by determining the aforementioned preliminarily reference value S′ (preliminary experiment) and an experiment to determine (calculate) the reference value S (experiment to calculate the reference value S), and thus there is no need to change other parameters. Accordingly, the reference value S can be determined easily and simply, which is advantageous.

In particular, in the case where the value of B is calculated using the above formula (5), even if the value of B varies during application of the coating liquid to the sheet 11 after determination of the reference value S, where the determined reference value S is thus used, calculation of the reference value S can be conducted again corresponding to such variation. Therefore, it is possible to apply the coating liquid 3 more accurately.

In the case where the value of B is determined on the basis of the above formula (3), the value of B is calculated from the composition of the coating liquid 3.

Such a value of B can be calculated before starting the application of the coating liquid 3 to the sheet 11.

In the case where the value of B is determined on the basis of the above formula (4), the mass before the coating liquid 3 is solidified (mass before solidification) and the mass after the coating liquid 3 is solidified (mass after solidification) after the coating liquid 3 is applied onto the sheet 11 are measured, for example. Then, the value of B is calculated on the basis of the mass before solidification and the mass after solidification thus obtained. In an experiment in which the value of B is determined on the basis of the above formula (4), the object to which the coating liquid 3 is applied is not specifically limited to the aforementioned sheet 11 with a strip shape. Examples of such an object include an aluminum cup, a glass sheet, and a cut piece of the sheet 11, in addition to the sheet 11.

The value of B can be calculated before application of the coating liquid 3 to the sheet 11 is started.

The mass before solidification and the mass after solidification are each a value measured, for example, by an electronic balance.

In the case where the value of B is determined on the basis of the above formula (5), the values of a, b, and c are calculated, after obtaining some patterns of data of B, ρ_L, and T by conducting a preliminary experiment, etc., in advance, by back-calculation from the obtained values of B, ρ_L and T.

Specifically, the values of a, b, and c are calculated, for example, as follows. That is, a plurality of types of the coating liquid 3 which are of the same kind, but in each of which the mass fraction of the component to be solidified in the coating liquid 3 is different from the others are prepared. The mass fraction in each type of the coating liquid can be calculated from the above formula (3) or (4). Further, the number of types of the coating liquid 3 with a different mass fraction is not specifically limited, but three types of the coating liquid respectively with different 3 levels of the mass fraction can be used, for example. Subsequently, the density ρ_L is measured for each of the plurality of types of the coating liquid 3, while changing the temperature T. The densitometer used for measuring the density is not specifically limited, and a conventionally known densitometer can be used therefor. The obtained values of the density ρ_L, the temperature T, and the aforementioned mass fraction are substituted into the above formula (5), so that the values of the coefficients a, b, and c are calculated, for example, using the least-squares method.

The value of B is calculated on the basis of the thus calculated values of a, b, c, and the measured values of the density ρ_L of the coating liquid 3 and the measured temperature T of the coating liquid 3.

Determination of the value of B on the basis of the above formula (5) enables the value of B to be determined in real time while the coating liquid 3 is applied onto the sheet 11. Therefore, the value of B can be determined more suitably.

The aforementioned coating apparatus 1 applies the coating liquid 3 onto the sheet 11 by discharging, from the coating unit 13, the coating liquid 3, which has been delivered to the coating unit 13 by the pump 7 while the mass flow rate of the coating liquid 3 is measured by the measuring unit 21. During this application, the measurement result D by the measuring unit 21 is transmitted to the control unit 23, and the control unit 23 causes the pump 7 to reduce the mass flow rate as the amount of liquid to be delivered when the measurement result D is determined to be larger than the reference value S. On the other hand, the control unit 23 causes the pump 7 to increase the mass flow rate as the amount of liquid to be delivered when the measurement result D is determined to be smaller than the reference value S.

In this way, while the mass flow rate of the coating liquid 3 to be delivered by the pump 7 is changed by the control unit 23, the coating liquid 3 is applied onto the sheet 11 by the coating unit 13, and the coating liquid 3 applied onto the sheet 11 is solidified by the solidification unit 27. Thus, the coating film 40 is formed.

According to such coating apparatus 1, the amount of the coating liquid 3 to be delivered can be measured by the measuring unit 21 arranged between the pump (liquid delivering unit) 7 and the coating unit 13, and therefore it is possible to suppress variation in the thickness of the coating film 40 more quickly with no waste, than in the case where the thickness of the coating film 40 is measured.

Moreover, the mass flow rate of the coating liquid 3, which is employed as an indicator of the amount of the coating liquid 3 to be delivered, is measured by the measuring unit 21, and the amount of the coating liquid 3 to be delivered can be adjusted on the basis of the measurement result D by the measuring unit 21 and the reference value S of the mass flow rate. Therefore, it is possible to suppress variation in the thickness of the coating film 40 more reliably than in the case where the volumetric flow rate is used as an indicator.

Thus, according to the coating apparatus 1 configured as above, it is possible to suppress variation in the thickness of the coating film 40 comparatively quickly and reliably with no waste.

In this embodiment, the control unit 23 adjusts the mass flow rate of the coating liquid 3, preferably within the range of ±10% of the reference value S, more preferably within the range of ±5% of the reference value S.

When the control unit 23 adjusts the mass flow rate of the coating liquid 3 within the range of ±10% of the reference value S as above, it is possible to suppress variation in the thickness of the coating film 40 more reliably with no waste.

A method for producing a coating film of this embodiment includes: by using the above described coating apparatus 1, forming the coating film 40 by applying the coating liquid 3 onto the sheet 11 by the coating unit 13 and solidifying the applied coating liquid 3 by the solidification unit 27, while measuring the mass flow rate of the coating liquid 3 by the measuring unit 21, and changing, by the control unit 23, the mass flow rate to be delivered by the pump 7 on the basis of the reference value S and the measurement result D by the measuring unit 21.

According to such a configuration, it is possible to suppress variation in the thickness of the coating film 40 comparatively quickly and reliably with no waste, in the same manner as above.

The coating apparatus and the method for producing a coating film according to the embodiments are as described above. However, the present invention is not limited to the above described embodiments, and the design thereof can be appropriately modified within the scope intended by the present invention. The operational advantage of the present invention is also not limited to the foregoing embodiments.

That is, the embodiments disclosed herein should be construed in all respects as illustrative but not limiting. The scope of the present invention is not indicated by the foregoing description but by the scope of the claims. The scope of the present invention is intended to include all the modifications equivalent in the sense and the scope to the scope of the claims.

### EXAMPLES

Next, the present invention is described further in detail by way of examples. However, the present invention is not limited to these examples.

These examples show experiments to actually calculate values of B by the above formulas (3) to (5) and experiments to check the validity of the calculated values of B.

### Experiment 1

Following the operations 1 to 4 below, the reference value S of the mass flow rate was calculated from the above formulas (1) and (2), using the value of B calculated from the above formula (3) or (4).

Operation 1 (Preliminary Experiment)

The value of B was calculated from the above formula (3) or the above formula (4).

Specifically, using two types of components as a component to be solidified contained in a coating liquid, which were a polymer component M (an acrylic adhesive obtained from a solution containing an acrylic polymer with a weight-average molecular weight of 2,200,000 (containing a component to be solidified at a concentration of 30 mass %)), and a polymer component N (an acrylic adhesive obtained from a solution containing an acrylic polymer with a weight-average molecular weight of 1,650,000 (containing a component to be solidified at a concentration of 30 mass %)), solvents were prepared as a solution medium. It should be noted that a coating liquid containing the polymer component M is referred to as a polymer-M solution, and a coating liquid containing the polymer component N is referred to as a polymer-N solution.

Then, the mass of a polymer component in a coating liquid with respect to the total mass of the coating liquid (mass fraction B) was calculated from the component ratio of each coating liquid as shown in Table 1 below. That is, the value of B calculated from the above formula (3) or the above formula (4) was as shown in Table 1.

Operation 2 (Preliminary Experiment)

For each coating liquid, the preliminarily reference value S′ of the mass flow rate was calculated using the above formulas (1) and (2).

Specifically, a width W of the coating liquid to be applied onto a sheet, a moving speed U of the sheet relative to a coating unit, and a set value t_ref of the thickness of the coating film applied to the sheet and solidified thereon were set as shown in Table 1. Further, a preliminarily set value ρ_a of the density of the coating film applied to the sheet and solidified thereon was set as shown in Table 1. As a reference value, a preliminarily reference value S′ of the mass flow rate calculated by substituting these values into the above formula (1) is shown in Table 1.

Under the conditions set as above, the coating liquid was applied, using the coating apparatus shown in FIG. 1, onto a polyethylene terephthalate (PET) film (MRF38, manufactured by Mitsubishi Plastics, Inc.) as a sheet and solidified thereon, thereby forming a coating film.

Table 1 also shows a measured value of the temperature T of the coating liquid.

Operation 3 (Preliminary Experiment)

A thickness t_ms of the coating film formed in Operation 2 above was measured using a contact-type displacement meter (linear gauge, manufactured by OZAKI MFG. CO., LTD.).

Then, the thus obtained t_ms and the aforementioned set values t_ref and ρ_a were substituted into formula (2), so that a density ρ_s of the coating film applied to the sheet and solidified thereon was calculated. Table 1 shows the results.

Operation 4 (Calculation of Reference Value S of Mass Flow Rate)

The value of ρ_s calculated in Operation 3 above, instead of the preliminarily set value ρ_a, the value of B calculated from the above formula (3) or (4), and the values of W, U, and t_ref set as shown in Table 2 were substituted into the above formula (1). Thus, the reference value S of the mass flow rate was calculated. Then, a coating film was formed in the same manner as in Operation 2 above.

Further, the thickness t_ms of the thus formed coating film was measured, which was compared with the set value t_ref. When the difference between the measured value t_ms and the set value t_ref (t_ms−t_ref) accounts for more than −10% and less than +10% with respect to the set value t_ref, the reference value S of the mass flow rate is regarded to be suitably set and is shown as “∘”. When it falls outside such a range (when the aforementioned difference accounts for −10% or less, or +10% or more, with respect to the set value t_ref), the reference value S of the mass flow rate is regarded not to be suitably set and is shown as “x”.

Table 2 shows the results.

In Table 2, the reason why the value of S was not suitably set in Experimental example 6 was that 0.12 was erroneously substituted into the above formula (1) as the mass fraction B of the coating liquid, despite that the actual value was 0.15. Therefore, 0.15, which was the correct value of the mass fraction, was substituted into the above formula (1), and then the value of S was suitably set as shown in Experimental example 7.

The reason why the value of S was not suitably set in Experimental example 8 was that 1111 was erroneously substituted into the above formula (1) as the density ρ_s of the coating liquid applied to the sheet and solidified thereon, despite that the actual value was 1250. Therefore, 1250, which was the correct value of ρ_s, was substituted into the above formula (1), and then the value of S was suitably set as shown in Experimental example 9.

TABLE 1

| | | Operation 1 | | | | | | | | | |
|---|---|---|---|---|---|---|---|---|---|---|---|
| | | B | Operation 2 | | | | | | | | |
| | | calculated | | | | | | | S′ | Operation 3 | |
| Coating Liquid | | by | | | | | | | calculated by | | ρ_s |
| Component | | Formula | Measured | Preliminary | Set | | | | Formula (1) | Measured | calculated by |
| to be | Solution | (3) or (4): | Value: | Set Value: | Value: | Set Value: | Set Value: | Set Value: | (Reference): | Value: | Formula (2): |
| solidified | Medium | B (—) | T (° C.) | ρ_a (kg/m³) | W (m) | U (m/min) | t_ref (m) | B (—) | S′ (kg/m³) | t_ms (m) | ρ_s (kg/m³) |
| Polymer | Solvent | 0.12 | 25 | 1000 | 1 | 20 | 2.0 × 10⁻⁵ | 0.12 | 3.333 | 1.8 × 10⁻⁵ | 1111 |
| M | | | | | | | | | | | |
| Polymer | Solvent | 0.12 | 25 | 1000 | 1 | 20 | 2.0 × 10⁻⁵ | 0.12 | 3.333 | 1.6 × 10⁻⁵ | 1250 |
| N | | | | | | | | | | | |

TABLE 2

| | Coating Liquid | | Operation 4 | | | | | | | | |
|---|---|---|---|---|---|---|---|---|---|---|---|
| | | Mass | | | | | | | S | | |
| | | Fraction of | | Set | | | | | calculated | | |
| | | Component | Measured | Value: | Set | | | Set | by | Measured | |
| | | to be | Value: | ρ_s | Value: | Set Value: | Set Value: | Value: | Formula (1): | Value: | Evaluation: |
| | Kind | solidified: (—) | T (° C.) | (kg/m³) | W (m) | U (m/min) | t_ref (m) | B (—) | S (kg/m³) | t_ms (m) | t_ref |
| Experimental | Polymer M | 0.12 | 25 | 1111 | 1 | 20 | 2.0 × 10⁻⁵ | 0.12 | 3.703 | 2.0 × 10⁻⁵ | ∘ |
| Example 1 | Solution | | | | | | | | | | |
| Experimental | Polymer M | 0.12 | 30 | 1111 | 1 | 20 | 2.0 × 10⁻⁵ | 0.12 | 3.703 | 2.0 × 10⁻⁵ | ∘ |
| Example 2 | Solution | | | | | | | | | | |
| Experimental | Polymer M | 0.12 | 25 | 1111 | 1.5 | 20 | 2.0 × 10⁻⁵ | 0.12 | 5.555 | 2.0 × 10⁻⁵ | ∘ |
| Example 3 | Solution | | | | | | | | | | |
| Experimental | Polymer M | 0.12 | 25 | 1111 | 1 | 10 | 2.0 × 10⁻⁵ | 0.12 | 1.852 | 2.0 × 10⁻⁵ | ∘ |
| Example 4 | Solution | | | | | | | | | | |
| Experimental | Polymer M | 0.12 | 25 | 1111 | 1 | 20 | 1.5 × 10⁻⁵ | 0.12 | 2.778 | 1.5 × 10⁻⁵ | ∘ |
| Example 5 | Solution | | | | | | | | | | |
| Experimental | Polymer M | 0.15 | 25 | 1111 | 1 | 20 | 2.0 × 10⁻⁵ | 0.12 | 3.703 | 2.5 × 10⁻⁵ | x |
| Example 6 | Solution | | | | | | | | | | |
| Experimental | Polymer M | 0.15 | 25 | 1111 | 1 | 20 | 2.0 × 10⁻⁵ | 0.15 | 2.963 | 2.0 × 10⁻⁵ | ∘ |
| Example 7 | Solution | | | | | | | | | | |
| Experimental | Polymer N | 0.12 | 25 | 1111 | 1 | 20 | 2.0 × 10⁻⁵ | 0.12 | 3.703 | 1.8 × 10⁻⁵ | x |
| Example 8 | Solution | | | | | | | | | | |
| Experimental | Polymer N | 0.12 | 25 | 1250 | 1 | 20 | 2.0 × 10⁻⁵ | 0.12 | 4.167 | 2.0 × 10⁻⁵ | ∘ |
| Example 9 | Solution | | | | | | | | | | |

### Experiment 2

Following the operations 1 to 4 below, the reference value S of the mass flow rate was calculated from the above formulas (1) and (2), using the value of B calculated from the above formula (5).

Operation 1 (Preliminary Experiment)

For use in the above formula (5), the temperature T and the density ρ_L of the coating liquid were measured.

Specifically, three types of coating liquid, which were of the same kind as used in Experiment 1 and in which the mass of the component to be solidified in the coating liquid with respect to the total mass of the coating liquid (mass fraction, which was calculated from the above formula (3) or (4)) was as shown in Table 3, were used as the coating liquid. As has been mentioned above, a coating liquid containing the polymer component M (polymer M) is referred to as a polymer-M solution, and a coating liquid containing the polymer component N (polymer N) is referred to as a polymer-N solution.

For each of those types of coating liquid with such a mass fraction, the temperature T and the density ρ_L of the coating liquid were measured using a densitometer (a density/specific gravity meter, manufactured by Kyoto Electronics Manufacturing Co., Ltd.), while the temperature was varied at three levels.

Table 3 shows the results.

Operation 2 (Preliminary Experiment)

For use in the above formula (5), the values of the coefficients a, b, and c were calculated.

Specifically, for each of the kinds of polymer components in the coating liquid, some patterns of data of B, ρ_L, and T measured in a preliminary experiment, as shown in Operation 1 above, were obtained. Then, the values of a, b, and c were calculated by back-calculation from the thus obtained values of B, ρ_L, and T, using the least-squares method.

Table 4 shows the results.

Operation 3 (Preliminary Experiment) For each type of coating liquid, the reference value S of the mass flow rate was calculated using the above formulas (1) and (2).

Specifically, the width W of the coating liquid applied onto a sheet, the moving speed U of the sheet relative to the coating unit, and the set value t_ref of the thickness of the solidified coating film were set as shown in Table 5. Further, the preliminarily set value ρ_a of the density of the coating film applied to the sheet and solidified thereon was set as shown in Table 5. Then, the values of a, b, and c, which were obtained above, and measured values of T and ρ_L were substituted into the above formula (5). Thus, the value of B was calculated. As a reference value, the preliminarily reference value S′ of the mass flow rate calculated by substituting these values into the above formula (1) is shown in Table 5.

Under the conditions set as above, the coating liquid was applied, using the coating apparatus shown in FIG. 1, onto a polyethylene terephthalate (PET) film (MRF, manufactured by Mitsubishi Plastics, Inc.) as a sheet and solidified thereon, thereby forming a coating film. Table 5 also shows the temperature T of the coating liquid.

Operation 4 (Preliminary Experiment)

The thickness t_ms of the coating film formed in Operation 3 above was measured using a contact-type displacement meter (linear gauge, manufactured by OZAKI MFG. CO., LTD.).

Then, the thus obtained t_ms and the aforementioned set values t_ref and ρ_a were substituted into formula (2), so that the density ρ_s of the sheet-coating film applied to the sheet was calculated. Table 5 shows the results.

Operation 5 (Calculation of Reference Value S of Mass Flow Rate)

The value of ρ_s calculated in Operation 4 above was used instead of the preliminarily set value ρ_a. Further, the temperature T and the density ρ_L of the coating liquid were measured. The value of B calculated by the above formula (5) from the thus measured values and the values of a, b, and c calculated in Operation 2 above was used. Furthermore, the values of W, U, and t_ref were set as shown in Table 6. These values were substituted into the above formula (1). Thus, the reference value S of the mass flow rate was calculated. Then, a coating film was formed in the same manner as in Operation 3.

Further, the thickness t_ms of the thus formed coating film was measured, which was compared with the set value t_ref. When the difference between the measured value t_ms and the set value t_ref (t_ms−t_ref) accounts for more than −10% and less than +10% with respect to the set value t_ref, the reference value S of the mass flow rate is regarded to be suitably set and is shown as “∘”. When it falls outside such a range (when the aforementioned difference accounts for −10% or less, or +10% or more, with respect to the set value t_ref), the reference value S of the mass flow rate is regarded not to be suitably set and is shown as “X”.

Table 6 shows the results.

The reason why the value of S was not suitably set in Experimental example 13 was that the value of B was calculated by erroneously substituting the values of the coefficients a, b, and c, which were different from the actual values, into the above formula (5). Therefore, the correct values of the coefficients a, b, and c were substituted therein, and then the value of S was suitably set as shown in Experimental example 14.

TABLE 3

| Coating Liquid | | Operation 1 | |
|---|---|---|---|
| | Mass Fraction of | Measured | Measured |
| | Component to be | Value: | Value: |
| Kind | solidified (—) | T (° C.) | ρ_l (kg/m³) |
| Polymer M Solution | 0.10 | 15 | 902 |
| Polymer M Solution | 0.10 | 25 | 891 |
| Polymer M Solution | 0.10 | 35 | 881 |
| Polymer M Solution | 0.12 | 15 | 908 |
| Polymer M Solution | 0.12 | 25 | 897 |
| Polymer M Solution | 0.12 | 35 | 887 |
| Polymer M Solution | 0.15 | 15 | 917 |
| Polymer M Solution | 0.15 | 25 | 906 |
| Polymer M Solution | 0.15 | 35 | 896 |
| Polymer N Solution | 0.10 | 15 | 925 |
| Polymer N Solution | 0.10 | 25 | 912 |
| Polymer N Solution | 0.10 | 35 | 899 |
| Polymer N Solution | 0.12 | 15 | 928 |
| Polymer N Solution | 0.12 | 25 | 915 |
| Polymer N Solution | 0.12 | 35 | 903 |
| Polymer N Solution | 0.15 | 15 | 933 |
| Polymer N Solution | 0.15 | 25 | 921 |
| Polymer N Solution | 0.15 | 35 | 908 |

TABLE 4

Operation 2

| | Calculated | Calculated | Calculated |
|---|---|---|---|
| | Value: | Value: | Value: |
| Coating Liquid | a (—) | b (—) | c (—) |
| Polymer M Solution | 3.27 × 10⁻³ | 3.44 × 10⁻³ | −2.90 |
| Polymer N Solution | 5.69 × 10⁻³ | 7.27 × 10⁻³ | −5.27 |

TABLE 5

| Coating Liquid | | | | | | | | |
|---|---|---|---|---|---|---|---|---|
| | | Mass | | | | | | |
| | | Fraction of | Operation 3 | | | | | |
| | | Component | | Preliminary | | | | |
| Component | | to be | Measured | Set | Set | | | |
| to be | Solution | solidified | Value: | Value: | Value: | Set Value: | Set Value: | Set Value: |
| solidified | Medium | (—) | T (° C.) | ρ_a (kg/m³) | W (m) | U (m/min) | t_ref (m) | a (—) |
| Polymer | Solvent | 0.12 | 25 | 1000 | 1 | 20 | 2.0 × 10⁻⁵ | 3.27 × 10⁻³ |
| M | | | | | | | | |
| Polymer | Solvent | 0.12 | 25 | 1000 | 1 | 20 | 2.0 × 10−5 | 5.69 × 10−3 |
| N | | | | | | | | |

| | | | | | | | Operation 4 | |
|---|---|---|---|---|---|---|---|---|
| Coating Liquid | | | | | | | | ρ_s |
| | | Mass | Operation 3 | | | | | calculated |
| | | Fraction of | | | | S′ | | by |
| | | Component | | | B calculated | calculated by | | Formula |
| Component | | to be | | Set | by | Formula (1) | Measured | (2): |
| to be | Solution | solidified | Set Value: | Value: | Formula (5): | (Reference): | Value: | ρ_s |
| solidified | Medium | (—) | b (—) | c (—) | B (—) | S′ (kg/m³) | t_ms (m) | (kg/m³) |
| Polymer | Solvent | 0.12 | 3.44 × 10⁻³ | −2.90 | 0.12 | 3.333 | 1.8 × 10⁻⁵ | 1111 |
| M | | | | | | | | |
| Polymer | Solvent | 0.12 | 7.27 × 10−3 | −5.27 | 0.12 | 3.333 | 1.6 × 10−5 | 1250 |
| N | | | | | | | | |

TABLE 6

| | Coating | | | | | | | |
|---|---|---|---|---|---|---|---|---|
| | Liquid | | | | | | | |
| | | Mass | | | | | | |
| | | Fraction of | | | | | | |
| | | Component | | | | | | |
| | | to be | Operation 5 | | | | | |
| | | solidified (B | | Set | | | | |
| | | calculated by | Measured | Value: | | | | |
| | | Formula | Value: | ρ_s | Set Value: | Set Value: | Set Value: | Set Value: |
| | Kind | (3),(4)): (—) | T (° C.) | (kg/m³) | W (m) | U (m/min) | t_ref (m) | a (—) |
| Experimental | Polymer | 0.12 | 25 | 1111 | 1 | 20 | 2.0 × 10⁻⁵ | 3.27 × 10⁻³ |
| Example 10 | M | | | | | | | |
| | Solution | | | | | | | |
| Experimental | Polymer | 0.11 | 25 | 1111 | 1 | 20 | 2.0 × 10⁻⁵ | 3.27 × 10⁻³ |
| Example 11 | M | | | | | | | |
| | Solution | | | | | | | |
| Experimental | Polymer | 0.13 | 25 | 1111 | 1 | 20 | 2.0 × 10⁻⁵ | 3.27 × 10⁻³ |
| Example 12 | N | | | | | | | |
| | Solution | | | | | | | |
| Experimental | Polymer | 0.12 | 25 | 1250 | 1 | 20 | 2.0 × 10⁻⁵ | 3.27 × 10⁻³ |
| Example 13 | N | | | | | | | |
| | Solution | | | | | | | |
| Experimental | Polymer | 0.12 | 25 | 1250 | 1 | 20 | 2.0 × 10⁻⁵ | 5.69 × 10⁻³ |
| Example 14 | N | | | | | | | |
| | Solution | | | | | | | |

| | Operation 5 | | | | | |
|---|---|---|---|---|---|---|
| | | | B | S | | |
| | | | calculated | calculated | | |
| | | | by | by | Measured | Evaluation: |
| | Set Value: | Set Value: | Formula (5): | Formula (1): | Value: | t_ref ≈ |
| | b (—) | c (—) | B (—) | S (kg/m³) | t_ms (m) | t_ms? |
| Experimental | 3.44 × 10⁻³ | −2.90 | 0.11 | 3.703 | 2.0 × 10⁻⁵ | ∘ |
| Example 10 | | | | | | |
| Experimental | 3.44 × 10⁻³ | −2.90 | 0.11 | 4.040 | 2.0 × 10⁻⁵ | ∘ |
| Example 11 | | | | | | |
| Experimental | 3.44 × 10⁻³ | −2.90 | 0.13 | 3.418 | 2.0 × 10⁻⁵ | ∘ |
| Example 12 | | | | | | |
| Experimental | 3.44 × 10⁻³ | −2.90 | 0.18 | 2.778 | 1.3 × 10⁻⁵ | x |
| Example 13 | | | | | | |
| Experimental | 7.27 × 10⁻³ | −5.27 | 0.12 | 4.167 | 2.0 × 10⁻⁵ | ∘ |
| Example 14 | | | | | | |

What is claimed is:

1. A coating apparatus comprising;
a coating unit configured to form a coating film by applying a coating liquid containing a component to be solidified onto a sheet that relatively moves and by solidifying the applied coating liquid;
a liquid delivering unit configured to deliver the coating liquid to the coating unit;
a measuring unit configured to measure a mass flow rate of the coating liquid and arranged between the liquid delivering unit and the coating unit; and
a control unit storing a reference value of the mass flow rate and configured to change the mass flow rate of the coating liquid to be delivered by the liquid delivering unit on the basis of the reference value and a measurement result by the measuring unit.

2. The coating apparatus according to claim 1, wherein
the reference value is determined on the basis of a mass fraction of the component to be solidified in the coating liquid that is applied onto the sheet.

3. The coating apparatus according to claim 2, wherein
the reference value is determined on the basis of the following formulas (1) and (2);
$$\begin{matrix}S = \frac{W \times U \times t\_ref \times ρ\_s}{B} & ( 1 ) \\ ρ\_s = \frac{t\_ref \times ρ\_a}{t\_ms} , & ( 2 )\end{matrix}$$
where
S: Reference value of mass flow rate (kg/min);
W: Set value of width of coating liquid applied to sheet (m);
U: Moving speed of sheet relative to coating unit (m/min);
t_ref: Set value of thickness of coating film applied to sheet and solidified thereon (m);
ρ_s: Density of coating film applied to sheet and solidified thereon (kg/m³):
B: Mass fraction of component to be solidified in coating liquid (−);
ρ_a: Preliminarily set value of density of coating film applied to sheet and solidified thereon (kg/m³): and
t_ms: Measured value of thickness of coating film applied to sheet and solidified thereon (m).

4. The coating apparatus according to claim 3, wherein
the B is determined using one of the following formulas (3) to (5):
$$\begin{matrix}B = \frac{\begin{matrix}Mass of component to be \\ solidified in coating liquid\end{matrix} }{\begin{matrix}( Mass of component to be \\ solidified in coating liquid )\end{matrix} + \begin{matrix}( Mass of component to be \\ removed due to \\ solidification from coating \\ liquid )\end{matrix}} & ( 3 ) \\ B = \frac{Mass of coating film after solidification}{Mass of coating film before solidification} & ( 4 ) \\ B = a \times ρ\_L + b \times T + c , & ( 5 )\end{matrix}$$
where
ρ_L: Measured value of density of coating liquid (kg/m³);
T: Temperature of coating liquid during application (° C.); and
a, b, c: Coefficient (−).

5. A method for producing a coating film, the method comprising:
by using the coating apparatus according to claim 1, forming a coating film by applying the coating liquid onto the sheet by the coating unit, while measuring the mass flow rate of the coating liquid by the measuring unit and changing, by the control unit, the mass flow rate to be delivered by the liquid delivering unit on the basis of the reference value and the measurement result by the measuring unit.
